(19) United States
(12) Patent Application Publication
(10) Pub. No.: US 2008/0256333 A1
(43) Pub. Date: Oct. 16, 2008

(54) SYSTEM AND METHOD FOR IGNORING FETCH PROTECTION

(76) Inventors: Kenneth J. Keltos, Patterson, NY (US); John Joseph Messenger, Newburgh, NY (US); Samuel Santiago, Bridgeport, CT (US); Richard Vincent Spadavecchia, Somers, NY (US)

Correspondence Address: IBM CORPORATION- AUSTIN (JVL);C/O VAN LEEUWEN & VAN LEEUWEN, PO BOX 90609, AUSTIN, TX, 78709-0609, US

(21) Appl. No.: 11/733,251

(22) Filed: Apr. 10, 2007

(51) Int. Cl. G06F 9/30

(52) U.S. Cl. 712/205

(57) ABSTRACT

A system, method, and program product is provided that receives an instruction to fetch data from a data page. The data page is associated with a storage key and a fetch protection bit, and the instruction is pointed to by the program status word (PSW) that includes a PSW key and an ignore fetch protection bit. The data is fetched from the data page when the PSW key is a non-zero value, the PSW key is different than the storage key, and both the fetch protection bit and the ignore fetch protection bit are set ON. However, the data is not fetched from the data page when the PSW key is a non-zero value, the PSW key is different than the storage key, the fetch protection bit is ON, and the ignore fetch protection bit is OFF.

### BACKGROUND OF THE INVENTION

1. Technical Field

The present invention relates to a system and method that allows fetching data from protected data areas in a mainframe computer system. More particularly, the present invention relates to a system and method that allows retrieval of data from a data page where fetch protection has been activated.

2. Description of the Related Art

Some mainframe computer systems, such as IBM's zSeries® computer systems, have control data associated with memory data pages (frames) that control access to the data stored in the data page. In a typical system, each data page includes 4K bytes of storage (memory). The control data that is associated with the data pages includes a “storage key” and a fetch protection bit. The storage key is a numerical value (e.g., from 0 to 15) that is used to determine which instructions can access (read/write) data in the data page.

Instructions used to access the data are pointed to and controlled by the Program Status Word (PSW). In a traditional system, the PSW includes a “state” indicating whether the PSW is in “supervisor” or “problem” state. Supervisor state is typically used by system processes and the problem state is typically used by user processes. The PSW also includes a PSW key that is a numerical value (e.g., 0 to 15) that is used to compare with the storage key in order to determine the access the instruction, pointed by the PSW, has to the data page associated with the storage key. The PSW also includes an instruction address. The instruction address is the address of the instruction that is being processed (e.g., a request to write bytes of data to the data page or a request to read bytes of data from the data page.

In a traditional system, when fetching data from a data page, a PSW running with a PSW key that is different than the data page's storage key can fetch data from the data page so long as the data page's fetch protection bit is not set (i.e. is “OFF”). However, if the data page's fetch protection bit is ON, the PSW's key needs to be the same as the storage key or the PSW's key needs to be set to zero. Setting a PSW key to zero allows the PSW to access (read or write) data regardless of whether the fetch protection bit is set ON or OFF and regardless of whether the PSW key is different than the storage key.

Some processes, such as monitors and other system processes, often access many data pages in order to perform various system functions, such as performance reporting and the like. While the process can run using a PSW key setting of zero in order to access data in any data page in the system, this presents certain challenges. A primary challenge of running these processes in key zero is the risk that the process will perform a “wild store.” A wild store is where the process stores data into the wrong data page. However, if these processes do not run in key zero, then they will be unable to fetch data from data pages where the data pages' fetch protection bit is set (ON) and the storage key is different from the PSW key.

### SUMMARY

It has been discovered that the aforementioned challenges are resolved using a system, method and computer program product that receives an instruction to fetch data from a data page. The data page is associated with a storage key and a fetch protection bit, and the instruction pointed by the program status word (PSW) that includes a PSW key and an ignore fetch protection bit. The data is fetched from the data page when the PSW key is a non-zero value, the PSW key is different than the storage key, and both the fetch protection bit and the ignore fetch protection bit are set ON. However, the data is not fetched from the data page when the PSW key is a non-zero value, the PSW key is different than the storage key, the fetch protection bit is ON, and the ignore fetch protection bit is OFF. In one embodiment, the page of data is a 4K byte storage page.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a diagram depicting two information handling systems capable of executing the methods described herein;

FIG. 2 is a diagram showing a program status word that includes an ignore fetch protection bit and a data page;

FIG. 3 is a flow diagram showing steps and decisions made in determining whether to fetch data given characteristics of the PSW being used to fetch the data and settings that have been applied to the data page where the data being fetched resides; and

FIG. 4 is a diagram showing a store instruction and a fetch instruction and corresponding results of each instruction based on settings in the PSW and the data page.

### DETAILED DESCRIPTION

The following is intended to provide a detailed description of an example of the invention and should not be taken to be limiting of the invention itself. Rather, any number of variations may fall within the scope of the invention, which is defined in the claims following the description.

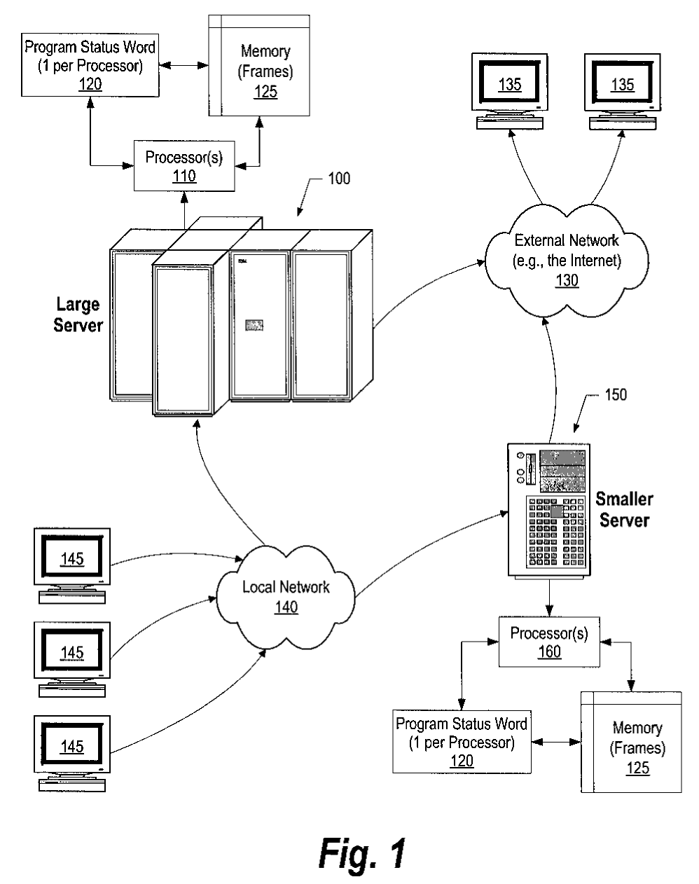

FIG. 1 is a diagram depicting two information handling systems capable of executing the methods described herein. FIG. 1 depicts two information handling system (100 and 150), with information handling system 100 being a large mainframe computer system, such as an IBM zSeries® mainframe computer system with one or more processors 110 and information handling system 150 being a smaller server computer system with one or more processors 160. In one embodiment, each of the information handling system runs IBM's z/OS® operating system or an operating system that is compatible with IBM's z/OS® operating system.

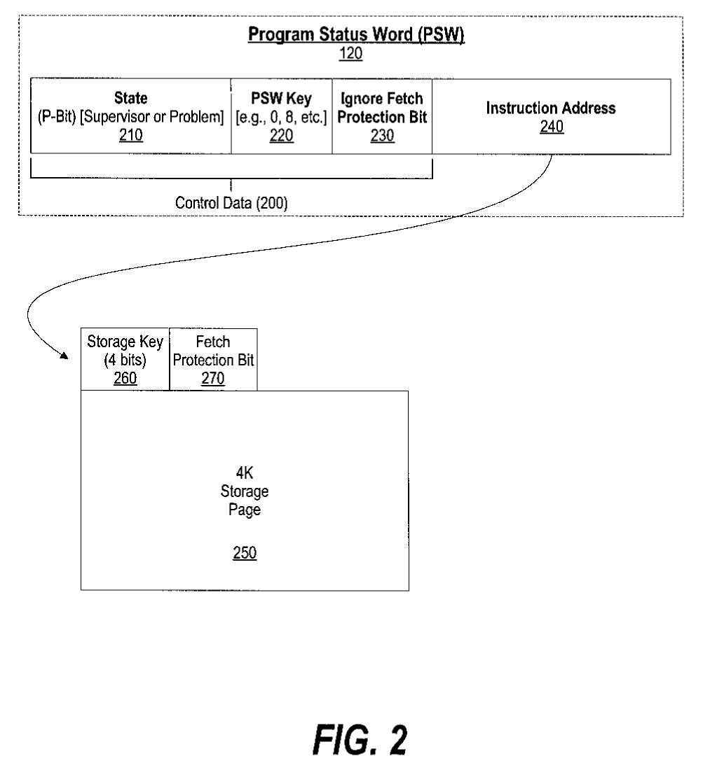

Each of the information handling system include one or more program status words (PSWs) 120, with one PSW being associated to each processor in each of the information handling systems. Each of the information handling system includes memory 125. Memory is divided into data pages, also known as “frames.” In one embodiment, each data page is 4K (4,096) bytes. Details of PSW 120 and data page 125 are shown in FIG. 2. These details include the PSW including an instruction address and control data that includes a state indicator, a PSW key, and an ignore fetch protection bit. These details also include a storage key and a fetch protection bit being associated with each data page.

Returning to FIG. 1, two different types of networks are shown interconnecting information handling system 100 and information handling system 150. External computer network 130, such as the Internet, is shown connecting workstations 135, such as personal computer systems, with the information handling systems. Local area network (LAN) 140 is also shown connecting workstations 145 to the information handling system. Typically, external network 130 is used to provide access to the information handling systems to users, such as customers and the like, that are outside the organization that operates the information handling systems. LAN 140 is typically used to provide access to users, such as employees, subcontractors, and others that are more closely associated with the organization.

While FIG. 1 shows one type of information handling system, an information handling system may take many forms. For example, an information handling system may take the form of a desktop, server, portable, laptop, notebook, or other form factor computer or data processing system. In addition, an information handling system may take other form factors such as a communication device or any other device that include a processor and memory.

FIG. 2 is a diagram showing a program status word that includes an ignore fetch protection bit and a data page. Program status word (PSW) 120 includes control data 200 and instruction address 240. Control data 200 is shown as including state 210, PSW key 220, and ignore fetch protection bit 230. State 210, also known as the “p-bit” (or “problem bit”) is a single bit field used to indicate if the PSW is in “supervisor state” (when the state is zero, or OFF) or “problem state” (when the state is one, or ON).

PSW key 220 is used to store the key of the PSW. In one embodiment, the PSW key is a four bit field and, thus, is able to store a value from 0 to 15 (binary ‘0000’ to ‘1111’). When running with PSW key zero (binary ‘0000’), instruction at address 240 can read (fetch) or write (store) into any data page 250 regardless of the settings (storage key 260 and fetch protection bit 270) of data page 250 that is being accessed. When running with a non-zero PSW key, the instruction at the PSW address is only able to store data into data pages that have the same key (i.e. the PSW key is equal to the storage key). When fetching data using a non-zero PSW key, the instruction at the PSW address is able to fetch data from data pages with different storage keys so long as the data page's fetch protection bit is not set (‘0’ or OFF). When fetching data, if the non-zero PSW key is different than the storage key and the fetch protection bit is set, then the instruction in the PSW can fetch the data if ignore fetch protection bit 230 is set (is ‘1’ or ON), but the fetch will fail if ignore fetch protection bit 230 is not set (is ‘0’ or OFF).

In one embodiment, ignore fetch protection bit 230 can only be set by PSWs running in supervisor state (state 210 being set OFF or ‘0’). This prevents user code running in problem state (state 210 being set ON or ‘1’) from setting ignore fetch protection bit ON and, thus, prevents the user code from accessing sensitive data in data pages where the fetch protection bit has been set.

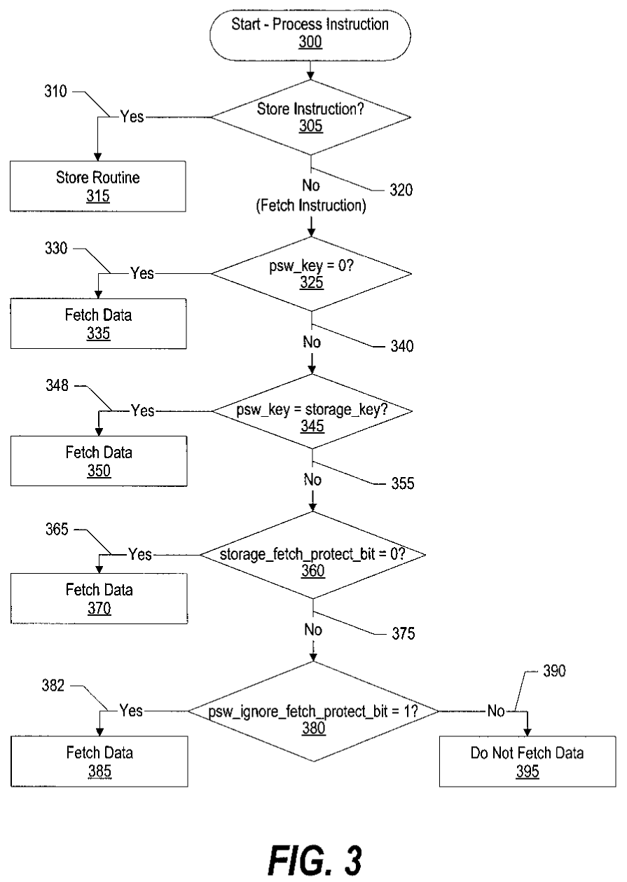

FIG. 3 is a flow diagram showing steps and decisions made in determining whether to fetch data given characteristics of the PSW being used to fetch the data and settings that have been applied to the data page where the data being fetched resides. Processing of the PSW is shown commencing at 300 whereupon, a determination is made as to whether the PSW processes an instruction to store data in a particular data page. If the PSW's instruction is to store data (i.e. one or more bytes) in a particular data page, then decision 305 branches to “yes” branch 310 and, at step 315, a store routine is performed that determines whether the data can be stored in the data page based on the control data included in the PSW and the storage key of the data page. If the PSW key is zero, then the data is stored in the data page. If the PSW key is a non-zero value, then the data is stored in the data page if the PSW key is the same as the storage key. However, if the PSW key is different than the storage key, than an error occurs and the data is not stored in the data page.

If the instruction is not a store instruction and, instead, is a fetch instruction, then decision 305 branches to “no” branch 320 whereupon another determination is made as to whether the PSW key is zero (decision 325). If the PSW key is zero, then decision 325 branches to “yes” branch 330 whereupon, at step 335, the requested data is fetched from the data page.

On the other hand, if the PSW key is not zero, then decision 325 branches to “no” branch 340 whereupon another determination is made as to whether the PSW key is the same as (equal to) the data page's storage key (decision 345). If the PSW key and the data page's storage are the same, then decision 345 branches to “yes” branch 348 whereupon, at step 350, the requested data is fetched from the data page.

However, if the PSW key is not zero and is not the same as the data page's storage key, then decision 345 branches to “no” branch 355 whereupon another determination is made as to whether the data page's storage fetch protection bit is OFF (equal to ‘0’). If the data page's storage fetch protection bit is OFF, then decision 360 branches to “yes” branch 365 whereupon, at step 370, the requested data is fetched from the data page.

On the other hand, if the data page's storage fetch protection bit is ON (equal to ‘1’), then decision 360 branches to “no”/branch 375 whereupon another determination is made as to whether the PSW's ignore fetch protection bit is set (decision 380). If the PSW's ignore fetch protection bit is set (equal to ‘I’), then decision 380 branches to “yes” branch 382 whereupon, at step 385, the requested data is fetched from the data page. On the other hand, if the PSW's ignore fetch protection bit is not set (is equal to ‘0’), then decision 380 branches to “no” branch 390 whereupon, at step 395, an error occurs and the system does not allow (disallows) the fetching of the data from the data page.

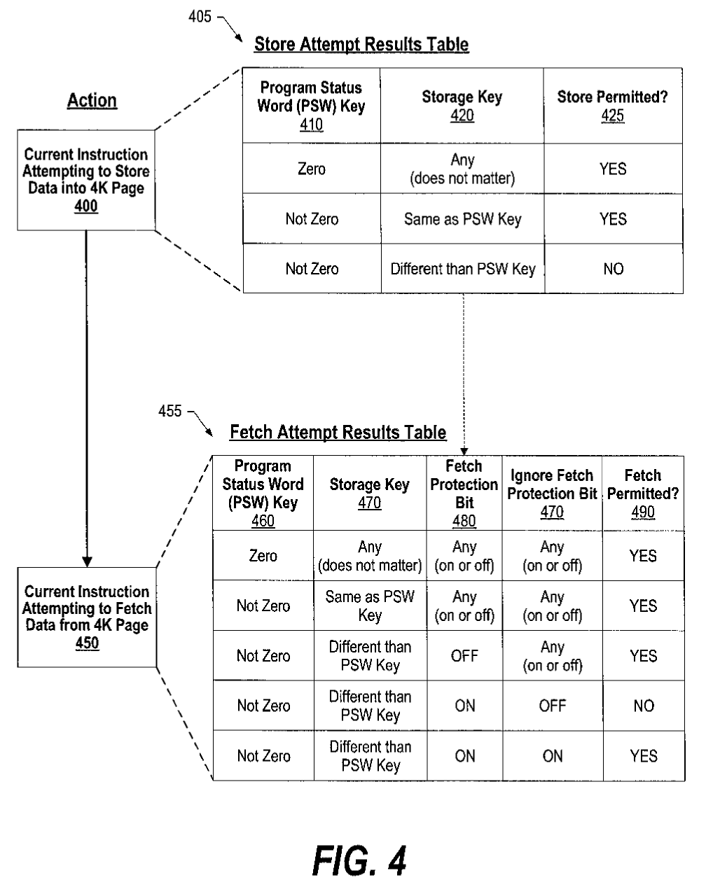

FIG. 4 is a diagram showing a store instruction and a fetch instruction and corresponding results of each instruction based on settings in the PSW and the data page. Action 400 occurs when the current PSW's instruction attempts to store data into a data page. Store attempt results table 405 depicts the various possibilities for a storage attempt. The PSW key (column 410) and (possibly) the storage key (column 420) are analyzed to determine whether the store is allowed (“Store Allowed?” result column 425). The first row indicates that if the PSW key is zero the store is permitted regardless of the value of the storage key. The second row and third rows are used when the PSW key is a non-zero value. The second row indicates that if the PSW key is the same as the data page's storage key then the store is permitted (e.g., if both the PSW key and the storage key are equal to ‘8’). The third row indicates that if the PSW key is non-zero and the PSW key is different than the data page's storage key (e.g., the PSW key is ‘8’ and the storage key is ‘0’), then the store is not permitted.

Action 450 occurs when the current PSW's instruction attempts to fetch data from a data page. Fetch attempt results table 455 depicts the various possibilities for a fetch attempt. The PSW key (column 460) and (possibly) the storage key (column 470), the fetch protection bit (column 475), and the ignore fetch protection bit (column 480) are analyzed to determine whether the fetch is allowed (“Fetch Allowed?” result column 490).

The first row indicates that if the PSW key (column 460) is equal to zero the fetch is permitted regardless of the value of the data page's storage key (column 470), the fetch protection bit setting (column 475), and the ignore fetch protection bit setting (column 480).

The second row indicates that if the PSW key (column 460) is a non-zero value but is equal to the data page's storage key (column 470), then the fetch is permitted regardless of the value of the fetch protection bit setting (column 475), and the ignore fetch protection bit setting (column 480).

The third row indicates that if the PSW key (column 460) is a non-zero value and is not equal to the data page's storage key (column 470), and the fetch protection bit setting is OFF (column 475) then the fetch is permitted regardless of the value of the ignore fetch protection bit setting (column 480).

The fourth row indicates that if the PSW key (column 460) is a non-zero value and is not equal to the data page's storage key (column 470), and the fetch protection bit setting is ON (column 475) then the fetch is not permitted if the ignore fetch protection bit setting is OFF (column 480).

Finally, the fifth row indicates that if the PSW key (column 460) is a non-zero value and is not equal to the data page's storage key (column 470), and the fetch protection bit setting is ON (column 475) then the fetch is permitted if the ignore fetch protection bit setting is ON (column 480).

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method comprising:
receiving a first instruction to fetch a first set of one or more bytes from a data page, wherein the data page is associated with a storage key and a fetch protection bit, and wherein the instruction is pointed to by a program status word (PSW) that includes a PSW key and an ignore fetch protection bit;
fetching the first set of bytes from the data page in response to the first PSW key being a non-zero value, the first PSW key being different than the storage key, and both the fetch protection bit and the ignore fetch protection bit being ON; and
disallowing a fetch of the first set of bytes in response to the first PSW key being a non-zero value, the first PSW key being different than the storage key, the fetch protection bit being ON, and the ignore fetch protection bit being OFF.

2. The method of claim 1 further comprising:
fetching the first set of bytes from the data page in response to the first PSW key being zero.

3. The method of claim 1 further comprising:
fetching the first set of bytes from the data page in response to the first PSW key being a non-zero value, and the first PSW key being the same as the storage key.

4. The method of claim 1 further comprising:
fetching the first set of bytes from the data page in response to the first PSW key being a non-zero value, the first PSW key being different than the storage key, and the ignore fetch protection bit being OFF.

5. The method of claim 1 further comprising:
receiving a second instruction to store a second set of bytes to the data page, wherein the second instruction is included in a second PSW that includes a second PSW key;
storing the second set of bytes in the data page in response to the second PSW key being zero;
storing the second set of bytes in the data page in response to the second PSW key being non-zero and the second PSW key being the same as the storage key; and
disallowing a store of the second set of bytes in response to the second PSW key being non-zero and the second PSW key being different than the storage key.

6. The method of claim 1 wherein the page of data is a 4K byte storage page.

7. The method of claim 1 wherein the PSW further includes a state bit, the method further comprising:
prior to receiving the first instruction, receiving a request to set the ignore fetch protection bit;
in response to the request:
setting the ignore fetch protection bit if the state bit indicates that the PSW is operating in a supervisor state; and
disallowing the setting of the ignore fetch protection bit if the state bit indicates that the PSW is not operating in the supervisor state.

8. A information handling system comprising:
one or more processors, wherein each of the processors is associated with a program status word (PSW) and each of the PSWs includes a PSW key and an ignore fetch protection bit;
a memory accessible by at least one of the processors;
a first instruction stored in the memory, the first instruction requesting to fetch a first set of one or more bytes from a data page included in the memory, wherein the data page is associated with a storage key and a fetch protection bit also stored in the memory, and wherein the first instruction is included in a first PSW that includes a first PSW key and an ignore fetch protection bit, wherein a first of the one or more processors executes the first instruction in order to perform actions of:
fetching the first set of bytes from the data page in response to the first PSW key being a non-zero value, the first PSW key being different than the storage key, and both the fetch protection bit and the ignore fetch protection bit being ON; and
disallowing a fetch of the first set of bytes in response to the first PSW key being a non-zero value, the first PSW key being different than the storage key, the fetch protection bit being ON, and the ignore fetch protection bit being OFF.

9. The information handling system of claim 8 wherein the actions further comprise:
fetching the first set of bytes from the data page in response to the first PSW key being zero.

10. The information handling system of claim 8 wherein the actions further comprise:
fetching the first set of bytes from the data page in response to the first PSW key being a non-zero value, and the first PSW key being the same as the storage key.

11. The information handling system of claim 8 wherein the actions further comprise:
fetching the first set of bytes from the data page in response to the first PSW key being a non-zero value, the first PSW key being different than the storage key, and the ignore fetch protection bit being OFF.

12. The information handling system of claim 8 wherein the actions further comprise:
receiving a second instruction to store a second set of bytes to the data page, wherein the second instruction is included in a second PSW that includes a second PSW key;
storing the second set of bytes in the data page in response to the second PSW key being zero;
storing the second set of bytes in the data page in response to the second PSW key being non-zero and the second PSW key being the same as the storage key; and
disallowing a store of the second set of bytes in response to the second PSW key being non-zero and the second PSW key being different than the storage key.

13. The information handling system of claim 8 wherein the page of data is a 4K byte storage page.

14. A computer program product in a computer readable medium, comprising functional descriptive material that, when executed by an information handling system, causes the information handling system to perform actions that include:
receiving a first instruction to fetch a first set of one or more bytes from a data page, wherein the data page is associated with a storage key and a fetch protection bit, and wherein the instruction is pointed to by a program status word (PSW) that includes a PSW key and an ignore fetch protection bit;
fetching the first set of bytes from the data page in response to the first PSW key being a non-zero value, the first PSW key being different than the storage key, and both the fetch protection bit and the ignore fetch protection bit being ON; and
disallowing a fetch of the first set of bytes in response to the first PSW key being a non-zero value, the first PSW key being different than the storage key, the fetch protection bit being ON, and the ignore fetch protection bit being OFF.

15. The computer program product of claim 14 wherein the actions further comprise:
fetching the first set of bytes from the data page in response to the first PSW key being zero.

16. The computer program product of claim 14 wherein the actions further comprise:
fetching the first set of bytes from the data page in response to the first PSW key being a non-zero value, and the first PSW key being the same as the storage key.

17. The computer program product of claim 14 wherein the actions further comprise:
fetching the first set of bytes from the data page in response to the first PSW key being a non-zero value, the first PSW key being different than the storage key, and the ignore fetch protection bit being OFF.

18. The computer program product of claim 14 wherein the actions further comprise:
receiving a second instruction to store a second set of bytes to the data page, wherein the second instruction is included in a second PSW that includes a second PSW key;
storing the second set of bytes in the data page in response to the second PSW key being zero;
storing the second set of bytes in the data page in response to the second PSW key being non-zero and the second PSW key being the same as the storage key; and
disallowing a store of the second set of bytes in response to the second PSW key being non-zero and the second PSW key being different than the storage key.

19. The computer program product of claim 14 wherein the page of data is a 4K byte storage page.

20. The computer program product of claim 14 wherein the PSW further includes a state bit, and wherein the actions further include:
prior to receiving the first instruction, receiving a request to set the ignore fetch protection bit;
in response to the request:
setting the ignore fetch protection bit if the state bit indicates that the PSW is operating in a supervisor state; and
disallowing the setting of the ignore fetch protection bit if the state bit indicates that the PSW is not operating in the supervisor state.
